(19) United States
(12) Patent Application Publication
(10) Pub. No.: US 2009/0021485 A1
(43) Pub. Date: Jan. 22, 2009

(54) ERGONOMIC THUMB SUPPORT DEVICE FOR A HAND-HELD DEVICE

(76) Inventor: Rochelle Shapera-Gill, Toronto (CA)

Correspondence Address: HERMAN & MILLMAN, 141 ADELAIDE ST. WEST, SUITE 1002, TORONTO, ON, M5H 3L5, CA

(21) Appl. No.: 11/778,333

(22) Filed: Jul. 16, 2007

(51) Int. Cl. G06F 3/02

(52) U.S. Cl. 345/169

(57) ABSTRACT

In one aspect, the present invention is directed to a thumb support device for use with a hand-held device that is held using a single hand and that included a thumb control. The hand-held device may have an input/output device on it, such as a display screen or a microphone. The hand-held device is configured in such a way that, for the user to use the input/output device, the user holds the hand-held device in at least approximately a palm-up orientation. For example, the hand-held device may include a display screen on its front face and may be held by the user with their hand in a palm-up orientation to position the display screen for viewing. As another example, the hand-held device may include a microphone on its top and may be held proximate the user's mouth in use, with the user's palm facing generally medially. The thumb support device supports the user's thumb while the user operates the thumb control. The thumb support device may be provided separately from the hand-held device. For example, the thumb support device may be provided as a retrofit kit for mounting onto a new or pre-existing hand-held device. Alternatively the thumb support device could be incorporated directly into the hand-held device. In another aspect, the present invention is directed to a hand-held device that includes the thumb support device. The thumb support device may be retractable. Optionally, the thumb support device includes a biasing member to urge the thumb support member towards a selected position.

### FIELD OF THE INVENTION

The present invention relates to hand-held devices, such as PDAs (personal digital assistants) and more particularly to portions of hand-held devices configured for supporting the thumb and fingers of a user.

### BACKGROUND OF THE INVENTION

Hand-held devices, such as PDAs (personal digital assistants), cell phones and voice recorders are in common use today. In many instanced, these devices are designed to be held and operated using one hand. An example is the Blackberry™ by Research In Motion Inc.

Such use can potentially result in discomfort in the thumb and hand of the user after some period of time, and can potentially have long term consequences.

### SUMMARY OF THE INVENTION

In one aspect, the present invention is directed to a thumb support device for use with a hand-held device that is held using a single hand and that has a thumb control mounted on it. The hand-held device may have an input/output device on it, such as a display screen or a microphone. The hand-held device is configured in such a way that, for the user to use the input/output device, the user holds the hand-held device in at least approximately a palm-up orientation. For example, the hand-held device may include a display screen on its front face and may be held by the user with their hand in a palm-up orientation to position the display screen for viewing. As another example, the hand-held device may include a microphone on its top and may be held proximate the user's mouth in use, with the user's palm facing generally medially (laterally. The thumb support device supports the user's thumb while the user operates the thumb control. The thumb support device may be provided separately from the hand-held device. For example, the thumb support device may be provided as a retrofit kit for mounting onto a new or pre-existing hand-held device. Alternatively the thumb support device could be incorporated directly into the hand-held device. In another aspect, the present invention is directed to a hand-held device that includes the thumb support device. The thumb support device optionally includes a biasing member that biases the thumb support member towards a selected position. As a result, the thumb support member can accommodate some range of movement of the thumb of the user (eg. during operation of the thumb control) while still supporting the thumb of the user throughout that range of movement,

In another aspect, the present invention is directed to a thumb support device for use with a hand-held device, wherein the thumb support device is retractable. In another aspect, the present invention is directed to a hand-held device that includes the thumb support device.

### BRIEF DESCRIPTION OF THE DRAWINGS

The present invention will now be described by way of example only with reference to the attached drawings, in which,

FIG. 1a is a front elevation view of a hand-held device being held by a user; in accordance with the prior art;

FIG. 1b is a side elevation view of the hand-held device shown in FIG. 1a;

FIG. 2 is a perspective view of a user using the hand-held device, with a thumb support device mounted thereto;

FIG. 3 is a perspective view of the hand-held device and thumb support device shown in FIG. 2, wherein the thumb support device is in a deployed position;

FIG. 4 is a front elevation view of the hand-held device and thumb support device shown in FIG. 3;

FIG. 5 is a top plan view of the hand-held device and the thumb support device shown in FIG. 3;

FIG. 6 is a side elevation view of the hand-held device and the thumb support device shown in FIG. 3;

FIG. 7 is a sectional view of section 7-7 shown in FIG. 6;

FIG. 8 is a magnified view of a portion of the hand-held device and thumb support device shown in FIG. 7;

FIG. 9 is a front elevation view of the hand-held device shown in FIG. 4, with the thumb support device in a storage position;

FIG. 10 is a magnified sectional side view similar to FIG. 7, but with the thumb support device in a storage position;

FIG. 11 is a view of a hand-held device with a thumb support device incorporated therein in accordance with another embodiment of the present invention;

FIG. 12 is a sectional view of the hand-held device shown in FIG. 11;

FIG. 13 is a perspective view of a person using a hand-held device and thumb support device in accordance with another embodiment of the present invention; and

FIG. 14 is a magnified front elevation view of the hand-held device and thumb support device shown in FIG. 13.

### DETAILED DESCRIPTION OF THE INVENTION

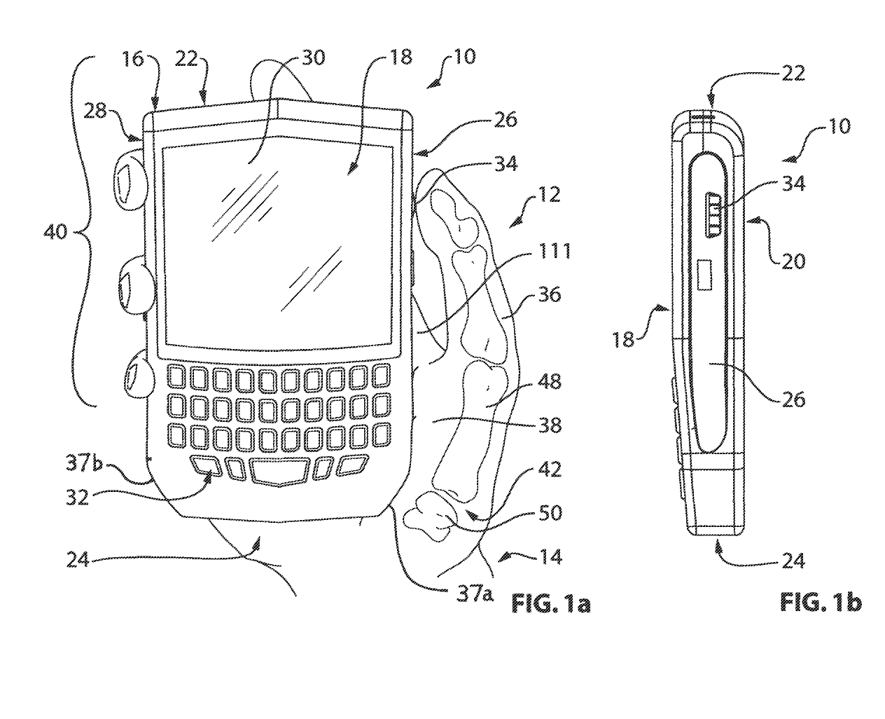

Reference is made to FIG. 1a, which shows a hand-held device 10 being held by a hand 12 of a user 14. The specific hand-held device 10 that is shown in FIG. 1a is a Blackberry™ 8700, which is made by Research in Motion, Inc, of Waterloo, Ontario, Canada, however, it will be appreciated that the hand-held device 10 could be a different device, by a different company. The hand-held device 10 includes a body 16, which has a front 18, a rear 20 (see FIG. 1b), a top 22, a bottom 24, and two side edges, including a right side edge 26 and a left side edge 28 (FIG. 1a).

On the front 18 of the hand-held device 10, there is an input/output device 29, such as a display screen 30 that is used to display output information to the user 14. Also on the front 18 is a keyboard 32 or keypad 32 for inputting information into the hand-held device 10, such as alphanumeric information.

On the right side edge 22 is positioned a thumb control 34, which may be, for example, a thumb wheel. The thumb control 34 permits the user 14 to control certain functions on the hand-held device 10, such as the positioning of a cursor on the display screen 30, using his/her thumb, shown at 36. At the bottom right and left corners of the hand-held device 10 are chamfers 37a and 37b.

During use of the hand-held device 10, the user 14 typically holds the hand-held device 10 in his/her hand 12 in such a way as to orient the input/output device in a selected way relative to the user 14. In the case of the hand-held device 10, it is typically held by the user 14 in such a way as to have the display screen 30 be viewable by the user 14. As a result, the user 14 typically has their hand 12 in a palm-up orientation,

The hand-held device 10 is typically captured by engagement of the heel of the palm, shown at 38, with the right chamfer 37 and with a portion of the right side edge 26, and by engagement of the tips of at least some of the other four fingers, shown collectively at 40, with the left side edge 28. When the hand-held device 10 is gripped in that way, the position of the trapezium, shown at 50, is related generally to the angle of the right chamfer 37. The position of the first metacarpal bone, however, is related at least in part by the angle of the right side edge 28. As a result of the relative angle of the right chamfer 37 and the right side edge 28, the first metacarpal bone 48 may be out of its neutral position relative to the trapezium 50. From an alternative viewpoint, the first metacarpal bone 48 is at least largely unsupported if the user positions the first metacarpal bone 48 in a generally neutral position relative to the trapezium 50. As a result of the lack of support, the carpometacarpal joint of the thumb 36, which is shown at 42, may have a relatively low amount of leverage during operation of the thumb control 34. Operation of the thumb control 34 with the thumb metacarpal bone 48 out of its neutral position relative to the trapezium 50 may result in discomfort to the user 14. If such prolonged operation takes place with sufficient frequency, there is a possibility of compromised joint congruency, ligament laxity, and degeneration in the components that make up the carpometacarpal joint 42.

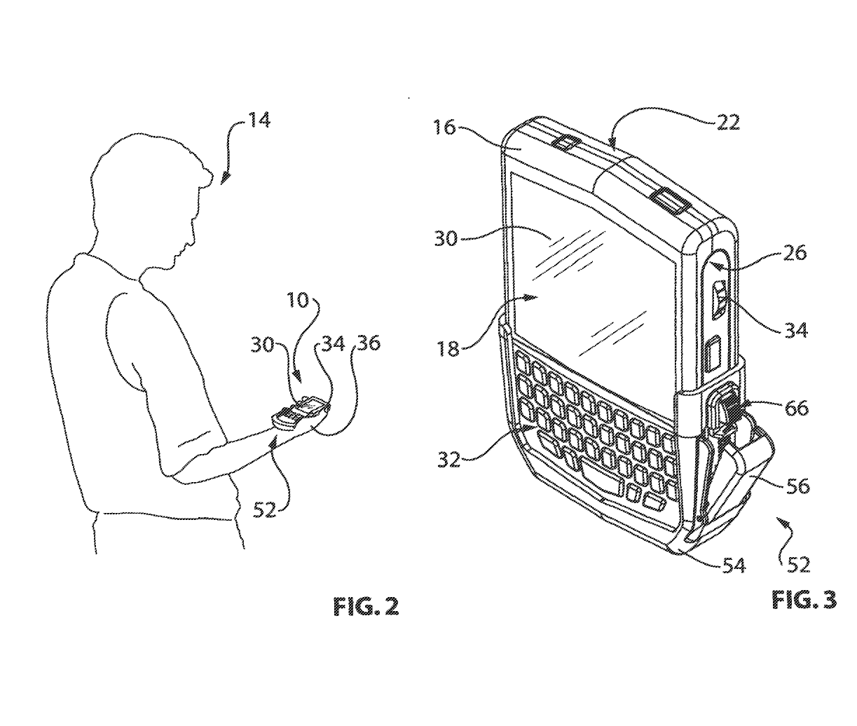

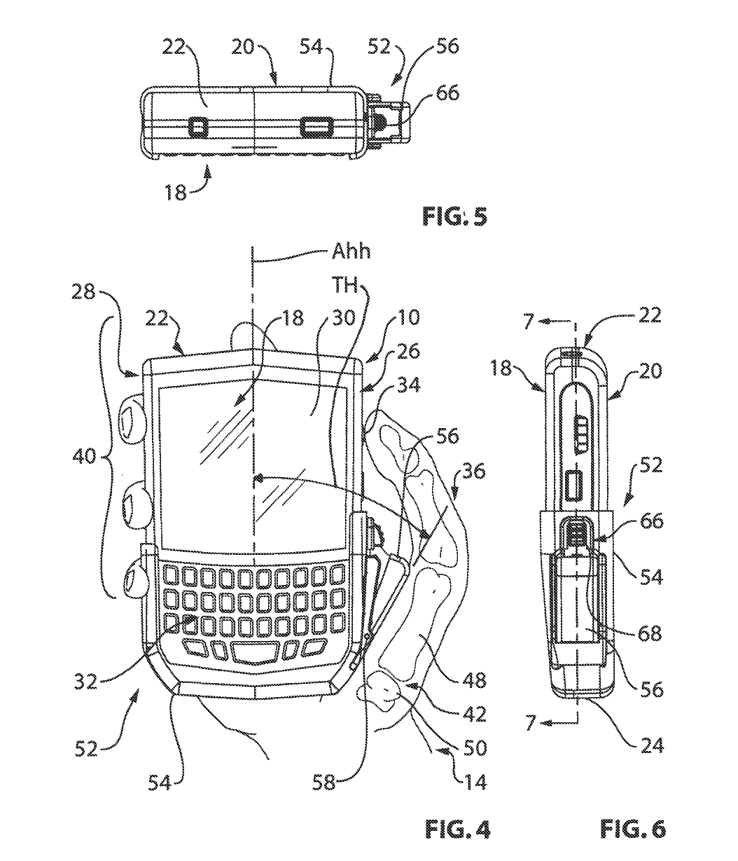

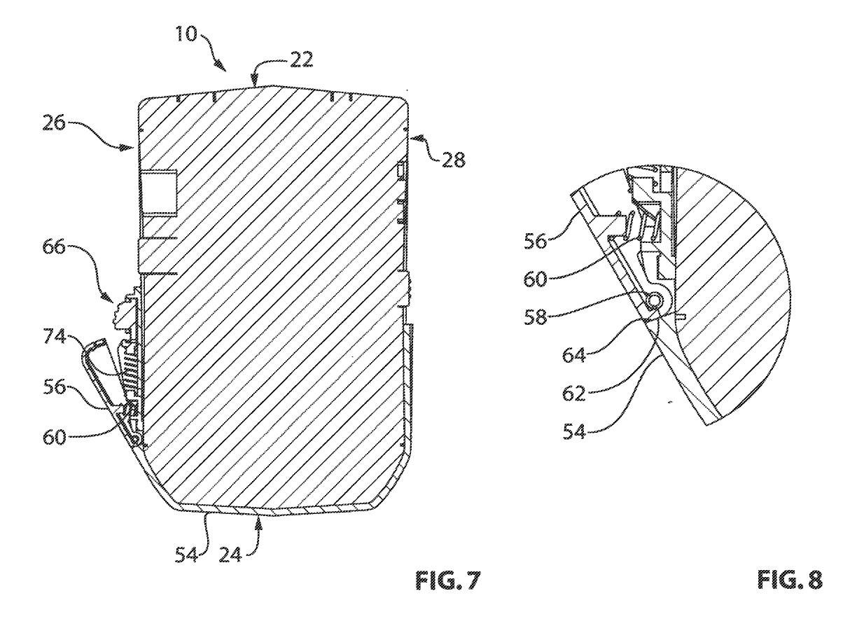

Reference is made to FIG. 2, which shows the user 14 using the hand-held device 10 with a thumb support device 52 in accordance with an embodiment of the present invention. The thumb support device 52 supports the thumb metacarpal bone 48 at a selected angle so that the carpometacarpal joint 42 of the thumb 36 at least approximately in its neutral position, as shown in FIG. 4. In doing so, the thumb support device 52 provides several advantages to the user 14. One advantage may be that the thumb support device 52 may decrease the degree of joint compression that takes place during operation of the thumb control 34, as a result of the increased joint congruency that it provides for the thumb carpometacarpal joint 42. Another advantage may be that the thumb support device 52 may reduce thumb and forearm muscle and tendon fatigue, which reduces the likelihood of a repetitive strain injury that originates in the soft tissue, since the thumb 36 operates with increased leverage since the carpometacarpal joint 42 is supported at least approximately in its neutral position.

The thumb support device 52 may provide similar benefits to the index finger of the user 14 when the user 14 is holding the hand-held device with two hands and is using his/her thumb to type with, and is using his/her index finger to operate the thumb control 34.

The thumb support device 52 includes a base 54 and a thumb support member 56. The base 54 is mountable to the body 16 of the hand-held device 10. The base 54 may have any suitable configuration. For example, the base 54 may cover a lower portion of the body 16 while having an opening in the area of the keyboard 32. The base 54 may further include an adhesive on its inner surface to assist in its being held on the body 16 of the hand-held device 10.

The thumb support member 56 supports the thumb 36 of the user 14 during operation of the thumb control 34. For example, the thumb support member 56 supports the carpometacarpal joint 42 in such a way as to urge the thumb metacarpal bone 48 towards its neutral position relative to the trapezium 50, relative to the positions of these bones shown in FIG. 1a, thereby potentially reducing the discomfort experienced by the user 14 during use of the hand-held device 10. In other words, using the thumb support device 52 may permit the user 14 to operate the hand-held device 10 for a longer period of time before experiencing discomfort. Viewed from another perspective, using the hand-held device 10 for a selected period of time with the thumb support device 52 may result in less discomfort for the user 14 than if he/she were to use the hand-held device 10 without the thumb support device 52.

The thumb support member 56 may support the thumb 36 of the user 14 at a selected angle, shown at TH, from the longitudinal axis of the hand-held device 10, shown at Ahh, in order to maintain the thumb metacarpal bone 48 in approximately neutral position relative to the trapezium 50. The selected angle TH may be any suitable angle, such as approximately 30 degrees. The selected angle TH may be different for different sizes of hand 12.

The thumb support member 56 may be biased towards the selected angle TH, instead of being fixed in position at the selected angle TH. As a result, some movement of the thumb support member 56 can accommodate movement of the thumb 36 when the thumb 36 operates the thumb control 34, while still supporting the thumb 36. Additionally, biasing the thumb support member 56 permits the thumb support device 52 to accommodate some range of sizes of thumbs 36 for different users 14. To achieve biasing of the thumb support member 56, the thumb support member 56 may be hingedly mounted to the base 54 by a hinge 58, and a thumb support member biasing member 60 (see FIG. 8) may be provided to urge the thumb support member 56 towards the selected angle TH. The thumb support member biasing member 60 may be any suitable device, such as a compression spring that connects between the thumb support member 56 and a suitable mount on the base 24.

As the user 14 operates the thumb control 34, he/she may momentarily cause the thumb support member 56 to move inwardly, thereby compressing the biasing member 60. For example, in embodiments wherein the thumb control 34 is a thumb wheel, the user 14 may roll the thumb wheel upwards, which causes his/her thumb to move the thumb support member 56 inwardly towards the side edge 26. After such compression takes place, the user 14 may move their thumb 36 in another direction permitting the thumb support member 56 to be urged back towards the selected position (ie. at angle TH). As the biasing member 60 urges the thumb support member 56 back towards its selected position, it assists the thumb metacarpal bone 48 in moving outwards. By assisting the thumb metacarpal bone 48 in this way, effort that would otherwise be required by the extensor muscles and tendons for the thumb 36 is reduced. This may result in less discomfort for the user 14 during use of the hand-held device 10.

The thumb support member 56 may be provided with a travel limit surface 62 that cooperates with a corresponding travel limit surface 64 on the base 54 to prevent the thumb support member 52 from being urged beyond the selected angle TH. The thumb support member biasing member 60 may have any selected spring constant, such as, for example, 1″ of compression per pound of force. The thumb support member biasing member 60 may be in a state of compression by some suitable amount when the thumb support member 56 is in its openmost position (ie, when it is in abutment with the base 24 at the selected angle TH).

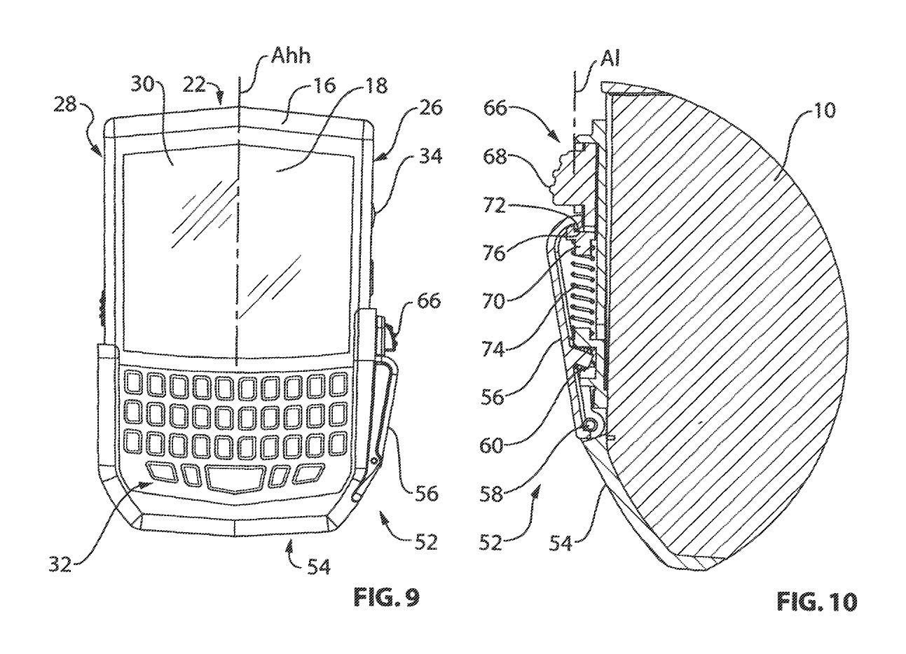

Another feature of the thumb support member 56 is that it may be retractable so that, when the hand-held device 10 is not in use, the thumb support member 56 may be moved (ie, retracted) to a ‘storage’ position as shown in FIG. 9. In the storage position, the thumb support member 56 extends out from the right side edge 26 less than it does when in the deployed position shown in FIG. 4, and may be less vulnerable to mechanical damage from being inadvertently being knocked or hooked by an object in its environment while being carried by the user 14 (FIG. 2). Additionally, the storage position permits the thumb support member 56 to be out of the way when the user 14 is typing on the keyboard 32.

The thumb support member 56 may be retained in the storage position (FIG. 9) by means of a latch 66. The latch 66 is shown more clearly in FIG. 10. The latch 66 may include a latch body 68 that may be movable along a vertical axis Al along the right side edge 26 of the hand-held device 10 to facilitate its actuation by the thumb 36 of the user 14 while being held in the hand 12 of the user 14. The latch body 68 may have a latch body hook 70 thereon that hooks a corresponding thumb support member hook 72 on the thumb support member 56. By engaging the latch body hook 70 with the thumb support member hook 72, the thumb support member 56 is held in the storage position against the urging of the thumb support member biasing member 60.

The latch body 68 may be biased towards its engaged position (shown in FIG. 10) by a latch body biasing member 74, which may be, for example, a compression spring which connects between the latch body 68 and a suitable mount on the base 24

To open the thumb support member 56 from its storage position, the user 14 (FIG. 2) moves the latch body 68 downwards, thereby releasing the engagement of the latch body hook 70 with the thumb support member hook 72. This, in turn, permits the thumb support member biased position requires a simple step of moving the latch body hook 70 out of the way of the thumb support member hook 72, so that the biasing member 60 can move the thumb support member 56 to its deployed position. To close the thumb support member 56 from its deployed position, the user 14 (FIG. 2) presses the thumb support member 56 towards the storage position (FIG. 9). During movement of the thumb support member 56 towards the storage position, the thumb support member 56 engages a latch body deflection surface 76 to urge the latch body 68 downwards out of its engaged position. Once the thumb support member hook 72 moves past the latch body hook 70, the latch body biasing member 74 urges the latch body hook 70 into engagement with the thumb support member hook 72 to hold the thumb support member 56 in its storage position.

The thumb support device 52 may be sold as a retrofit kit for mounting onto pre-existing hand-held devices 10, so that users 14 can continue to use those preexisting devices 10, while enjoying the benefits of increased thumb support. While the thumb support device 52 is shown as being configured for mounting to a Blackberry™ 8700, it will be appreciated that the thumb support device 52 could be provided with a configuration that is suitable for mounting to other hand-held devices, such as, for example, other models of Blackberry™, other PDAs (Personal Digital Assistants), or other devices such as cell phones, electronic organizers and the like.

It will be noted that, in embodiments where the hand-held device 10 has a pre-existing carrying case or holster associated therewith, it is possible that the hand-held device will no longer fit in the pre-existing carrying case or holster. A new carrying case or holster could optionally be provided with the thumb support device 52, that could be similar to the original carrying case or holster except for having additional room to accommodate the increased size of the hand-held device 10 due to the presence of the thumb support device 52 mounted thereon.

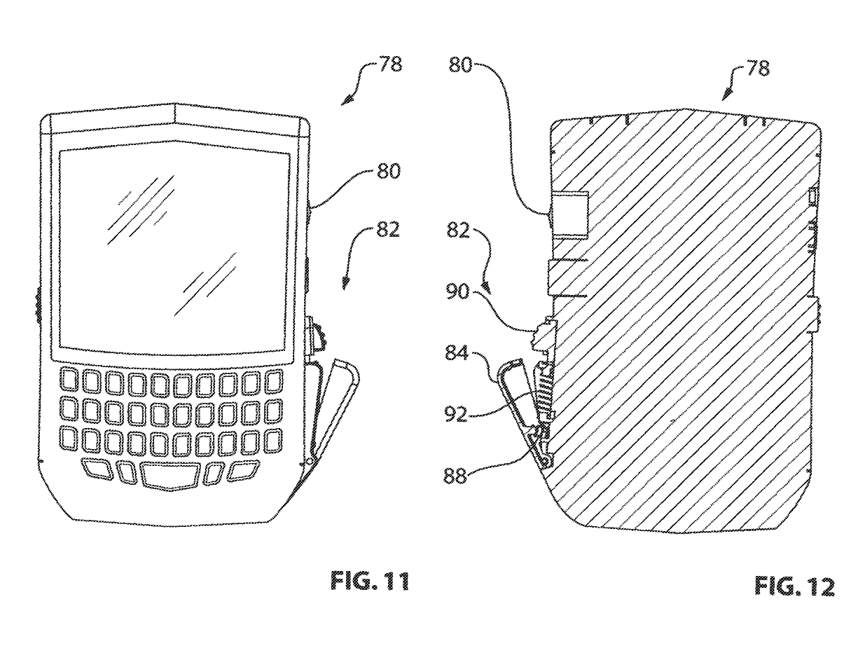

Reference is made to FIG. 11, which shows a hand-held device 78 that has a thumb control 80, and that has a thumb support device 82 incorporated directly therein, in accordance with another embodiment of the present invention. Aside from the direct incorporation of the thumb support device 82 therein, the hand-held device 78 may otherwise be similar to the hand-held device 10 (FIG. 4). Additionally, the thumb support device 82 may be similar to the thumb support device 52 (FIG. 4), except that the thumb support device 82 is directly incorporated into the hand-held device 78 and therefore does not require a separate base 54 (FIG. 4). The thumb support member, shown at 84 is hingedly connected to the body of the hand-held device, shown at 86. Similarly, the thumb support member biasing member, shown at 88, the latch body, shown at 90, and the latch body biasing member, shown at 92, are connected to the body 86.

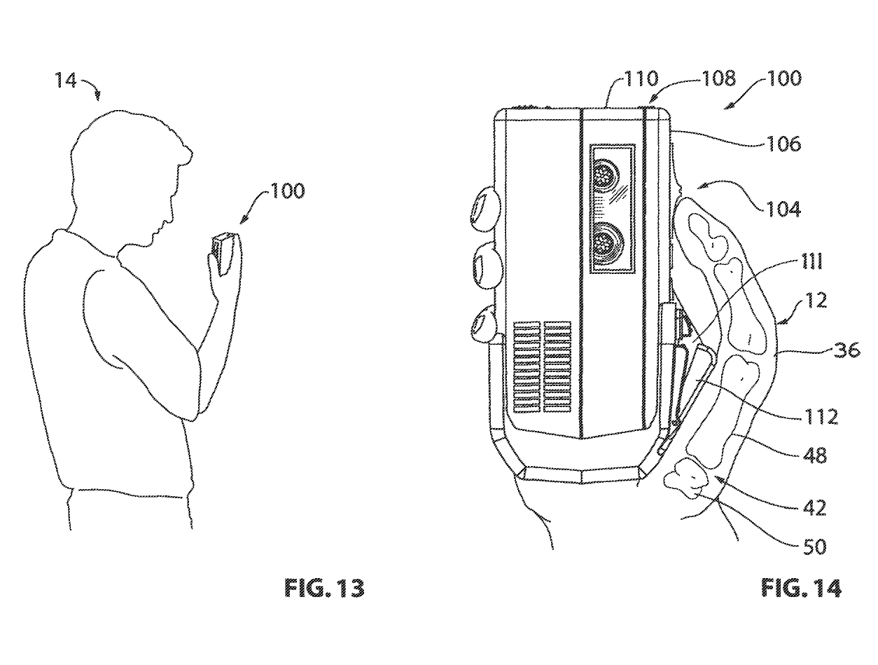

Reference is made to FIG. 14, which shows a hand-held device 100 that incorporates a thumb-support device 102 (FIG. 14). The hand-held device 100 may be, for example, a voice recorder, such as a Dictaphone™. The hand-held device 100 includes a thumb control 104 on it, that is configured for operation by the thumb 36 of the user 14 (FIG. 13). The thumb control 104 is positioned along a side edge, shown at 106. The hand-held device 100 includes an input/output device 108, such as a microphone along the top edge shown at 110. When the user 14 (FIG. 13) operates the hand-held device 110, the user 14 holds the device with the palm, shown at 111 of the user 14 faces generally medially so as to comfortably position the microphone in a suitable position proximate the mouth of the user 14, (see FIG. 13).

The thumb support device 102 may itself be similar to the thumb support device 52 (FIG. 4), and has a thumb support member 112 that supports the first metacarpal bone 48 in such a way that the carpometacarpal joint 42 is at least approximately in its neutral position. The advantages of such support are described above in relation to the thumb-support device 52.

The configurations described above for the thumb support devices 52, 82 and 102, have related to a hand-held device 10, 78 and 100 having a thumb control 34, 80, 104 mounted on the right side edge. It is contemplated that the hand-held device 10, 78, 100 could have a thumb-control 34, 80, 104 mounted on the left side edge for left-handed operation, and correspondingly, for the thumb support device 52, 82, 102 to be configured for operation on the left side edge to support the left thumb 36 of the user 14.

It has been shown and/or described for the thumb support device 52, 82, 102 to be retractable, or to be biased towards a selected angular position. It alternatively possible for the thumb support devices 52, 82, 102 to be fixed in position. In such an alternative embodiment, the thumb support member 56, 84, 112 would not require a hinged connection to the base, nor would it require an associated biasing member or latch.

As another alternative, the thumb support member 56, 84, 112 could itself be fixed in position, but could be made from a resilient compressible material, such as a foamed polymeric material, thereby simplifying the structure of the thumb support device 52, 82, 102, while still providing some biasing capability for the thumb support member 56, 84, 112.

The thumb controls described above are positioned along a side edge of the associated hand-held device. It is possible however, for a thumb support device in accordance with an aspect of the invention to be positioned elsewhere on the body of the hand-held device.

In general use of such hand-held devices as the Blackberry™ and a Dictaphone™ involve the user holding the device in a non-palm down orientation, whereby the thumb of the user is typically unsupported by the device or by a desk or the like. For example, the Dictaphone™ is held by the user with the hand in the air and with the palm facing generally medially. As another example, the Blackberry™ is typically held by the user with their hand in the air and with the palm facing generally upwards. When the hand of the user is held with the thumb unsupported in this manner, it is of particular advantage to support the thumb of the user.

While the above description constitutes a plurality of embodiments of the present invention it will be appreciated that the present invention is susceptible to further modification and change without departing from the fair meaning of the accompanying claims.

1. A hand-held device comprising:
a body;
an input/output device on the body, that is configured for positioning for use by a user with a hand in a non-palm-down orientation;
a thumb control on the body, wherein the thumb control is operable by a thumb on the hand of the user; and
a thumb support member positioned on the body to support the thumb of the user during operation of the thumb control.

2. A hand-held device as claimed in claim 1 wherein the hand-held device has a front face and a side edge and wherein the input-output device is on the front face and wherein the thumb control is on the side edge.

3. A hand-held device as claimed in claim 1, wherein the thumb support member is positioned to position the thumb metacarpal bone and the trapezium of the user in a generally neutral position relative to each other during operation of the thumb control.

4. A hand-held device as claimed in claim 1, wherein the hand-held device has a side edge and wherein the thumb support is positioned along the side edge.

5. A hand-held device as claimed in claim 1, wherein, in use, the thumb support member is movable between a deployed position and a storage position, wherein, in the storage position the thumb support member extends out less from the body than in the deployed position.

6. A hand-held device as claimed in claim 5, further comprising a latch that is operable by the thumb of the user, wherein the latch is configured to releasably retain the thumb support member in the storage position.

7. A hand-held device as claimed in claim 1, wherein the hand-held device has a longitudinal axis, and further includes a biasing member connected to the thumb support member, wherein the biasing member urges the thumb support towards a selected angle relative to the longitudinal axis.

8. A hand-held device as claimed in claim 7, wherein the selected angle is approximately 30 degrees.

9. A hand-held device as claimed in claim 7, wherein the thumb support member is hingedly connected to the body.

10. A hand-held device as claimed in claim 1, wherein the thumb control is a thumb wheel.

11. A hand-held device as claimed in claim 1, wherein the thumb support member is retractable.

12. A thumb support device that is retrofittable to a hand-held device, wherein the hand-held device includes a body, wherein the hand-held device has an input/output device on the body, that is configured for positioning for use by a user with a hand in at least approximately a non-palm-down orientation, and a thumb control that is operable by a thumb on the hand of the user, the thumb support device comprising:
a base, wherein the base is mountable to the body of the hand-held device; and
a thumb support member connected to the base, wherein the thumb support member is positioned to support the thumb of the user during operation of the thumb control.

13. A hand-held device as claimed in claim 12, wherein the hand-held device has a front face and a side edge and wherein the input-output device is on the front face and wherein the thumb control is on the side edge.

14. A thumb support device as claimed in claim 12, wherein the thumb support member is positioned to position the thumb metacarpal bone and the trapezium of the user in a generally neutral position relative to each other during operation of the thumb control.

15. A thumb support device as claimed in claim 12, wherein the hand-held device has a side edge and wherein the thumb support is positionable along the side edge.

16. A thumb support device as claimed in claim 12, wherein, in use, the thumb support member is movable between a deployed position and a storage position, wherein, in the storage position the thumb support member extends out less from the body than in the deployed position.

17. A thumb support device as claimed in claim 16, further comprising a latch that is operable by the thumb of the user, wherein the latch is configured to releasably retain the thumb support member in the storage position.

18. A thumb support device as claimed in claim 12, wherein the hand-held device has a longitudinal axis, and wherein the thumb support device further includes a biasing member connected to the thumb support member, wherein the biasing member urges the thumb support towards a selected angle from the longitudinal axis.

19. A thumb support device as claimed in claim 18, wherein the selected angle is approximately 30 degrees.

20. A thumb support device as claimed in claim 18, wherein the thumb support member is hingedly connected to the base.

21. A thumb support device as claimed in claim 12, wherein the thumb support member is retractable.

22. A thumb support device for use with a hand-held device, wherein the hand-held device includes a body, wherein the hand-held device has an input/output device on the body, that is configured for positioning for use by a user with a hand in a non-palm-down orientation, and a thumb control that is operable by a thumb on the hand of the user, wherein the thumb support device includes a thumb support member that is connected to the body and that is positioned to support the thumb of the user during operation of the thumb control.

23. A thumb support device as claimed in claim 22, wherein the hand-held device has a front face and a side edge and wherein the input-output device is on the front face and wherein the thumb control is on the side edge.

24. A thumb support device as claimed in claim 22, wherein the thumb support member is positioned to position the thumb metacarpal bone and the trapezium of the user in a generally neutral position relative to each other during operation of the thumb control.

25. A thumb support device as claimed in claim 22, wherein the hand-held device has a side edge and wherein the thumb support is positionable along the side edge.

26. A thumb support device as claimed in claim 22, wherein, in use, the thumb support member is movable between a deployed position and a storage position, wherein, in the storage position the thumb support member extends out less from the body than in the deployed position.

27. A thumb support device as claimed in claim 22, further comprising a latch that is operable by the thumb of the user, wherein the latch is configured to releasably retain the thumb support member in the storage position.

28. A thumb support device as claimed in claim 22, wherein the hand-held device has a longitudinal axis, and wherein the thumb support device further includes a biasing member connected to the thumb support member, wherein the biasing member urges the thumb support towards a selected angle from the longitudinal axis.

29. A thumb support device as claimed in claim 28, wherein the selected angle is approximately 30 degrees.

30. A thumb support device as claimed in claim 28, wherein the thumb support member is hingedly connected to the base.

31. A thumb support device as claimed in claim 22, wherein the thumb support member is retractable.

32. A hand-held device, comprising:
a body having a front, and at least one side edge;
a display screen on the front;
a thumb control on the at least one side edge, and wherein the thumb control is operable with a thumb of a hand of a user while the hand is holding the body in such a way as to face the display screen generally towards the face of the user; and
a thumb support member positioned on the body to position the thumb metacarpal bone and the trapezium of the user in a generally neutral position relative to each other during operation of the thumb control.
